(19) United States
(12) Patent Application Publication
(10) Pub. No.: US 2008/0122236 A1
(43) Pub. Date: May 29, 2008

(54) Exterior Lights Integrated In Air Deflector Of Roof Rack

(75) Inventor: Blake Peterson, Farmington Hills, MI (US)

Correspondence Address: YOUNG & BASILE, P.C., 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 11/563,609

(22) Filed: Nov. 27, 2006

(51) Int. Cl. B62D 33/00

(52) U.S. Cl. 296/3

(57) ABSTRACT

An exterior article carrier system for a vehicle includes a load carrier rack mountable to a roof a vehicle. An air deflector portion located adjacent a forward end of the rack extends between two side members for directing an apparent flow of air with respect to the rack as the rack is moved by the vehicle. At least one, and preferable two spacially separate light sources can be mounted within a single enclosure defined by the air deflector portion of the rack for casting radiant visible light in a direction forward of the vehicle to render objects in that direction visible. Bach light source can be located between the two side members and below uppermost edge of the air deflector portion of the roof rack. A rear portion of each light source can be concealed behind the air deflector portion of the rack.

### FIELD OF THE INVENTION

The present invention relates to an exterior load carrier associated with a vehicle roof, more particularly, a carrier having a wind deflecting mechanism to direct apparent flow of air passing around or through the carrier as the carrier is moved by the vehicle, and in combination with a light source mounted within the air deflector portion of the exterior article carrier system, where the light source cast a visible radiant light in a direction forward of the vehicle to render objects in that direction visible.

### BACKGROUND

Various configurations of exterior article carrier systems are known, for example U.S. Pat. No. 6,561,397; U.S. Design Pat. No. 481,003; U.S. Pat. Design No. 434,364; U.S. Patent Application Publication No. US 2006/0151554 A1; U. S. Patent Application Publication No. U.S. 2006/0086767 A1; and Japanese Publication No. JP2000052882. While these devices are suitable for supporting exterior articles or cargo, the devices lack decorative lights. Various light support systems are known, for example, U.S. Pat. No. 5,560,701 and Japanese Patent Publication No. JP 10119581. However, these devices are not suitable for supporting exterior articles or cargo. Fog lights and off road utility lights are common on light trucks and sport utility vehicles. In addition to providing the function of lighting, the fog and off road utility lights are consider decorative with respect to the vehicle. Various regulations govern the use of off road lights. For example, off road lights must be physically capped when the vehicle is in operation on public streets. Typically, off road lights are mounted to the front or roof of a vehicle.

Japanese Patent Publication No. JP10119581 discloses a sunroof deflector for an automobile additionally equipped with a lighting function. The sunroof deflector 10 is formed with a panel and has a front face 10a inclined upward to the rear and side faces 10d lowered toward the roof panel 1 from both sides of the front face 10a. A pair of lamps 20 emitting light forward are provided at both side portions of the front face 10a. As best seen in FIG. 2 the lamps 20 are recess mounted with a front lens that presents an unbroken contour in order to retain full aerodynamic effect of the air dam. This configuration sacrifices the decorative value of the lights.

### SUMMARY

An exterior article carrier system for vehicle can include a load carrier rack mountable to roof of a vehicle. The rack can have two side members and an air deflector portion located adjacent to a forward end of the rack extending between the two side members. The deflector portion directs an apparent air flow of air with respect to the rack as the rack is moved by the vehicle. At least one illumination light source can be mounted within the air deflector portion of the rack for casting visible radiant light in a direction forward of the vehicle to render objects in that direction visible. Integrating the light source with the air deflector does not significantly add turbulence, while allowing decorative, non-flush configurations to meet consumer styling preferences. Light sources located below the upper surface of the air deflector allow for less wind noise over the roof. The integration of light sources below the upper surface of the air deflector does not add to the height of the vehicle.

The article carrier is associated with the vehicle roof and includes a wind deflecting mechanism to direct the apparent flow of air passing through or around the article carrier in response to movement of the vehicle. The article carrier includes a light source to cast light in a forward direction to render objects in that direction visible. The light source is an element or material which converts energy into visible radiant energy. The illumination light source is supported by vehicle structure and is specially adapted for a four-wheeled automotive vehicle or motor car designed for passenger transportation on a street or a roadway, or off road, and can be propelled by any suitable engine configuration, including by way of example, and not limitation, an internal combustion engine using a volatile fuel, such as gasoline. The illumination light source is positioned on the roof of an automobile above the windshield. The illumination light source can include two spacially separate illuminating members. The illumination light source can be positioned within individual pockets or housings supported by a single case, enclosure, or compartment defined by the air or wind deflector portion of the load carrier rack.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is perspective view of an article carrier system for a vehicle including an air deflector portion and at least one illumination light source mounted within the air deflector portion of the load carrier rack;

FIG. 2 is plan view of the exterior article carrier system of FIG. 1;

FIG. 3 is side elevational view of the exterior article carrier system illustrated in FIGS. 1 and 2; and

FIG. 4 is a front elevational view of the exterior article carrier system illustrated in FIG. 1-3.

### DETAILED DESCRIPTION

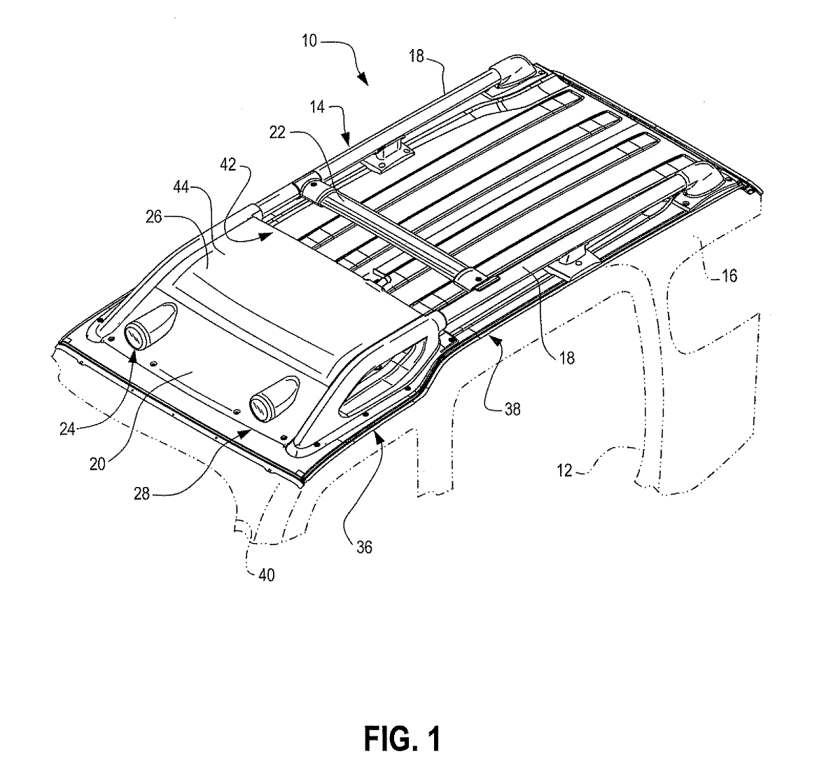

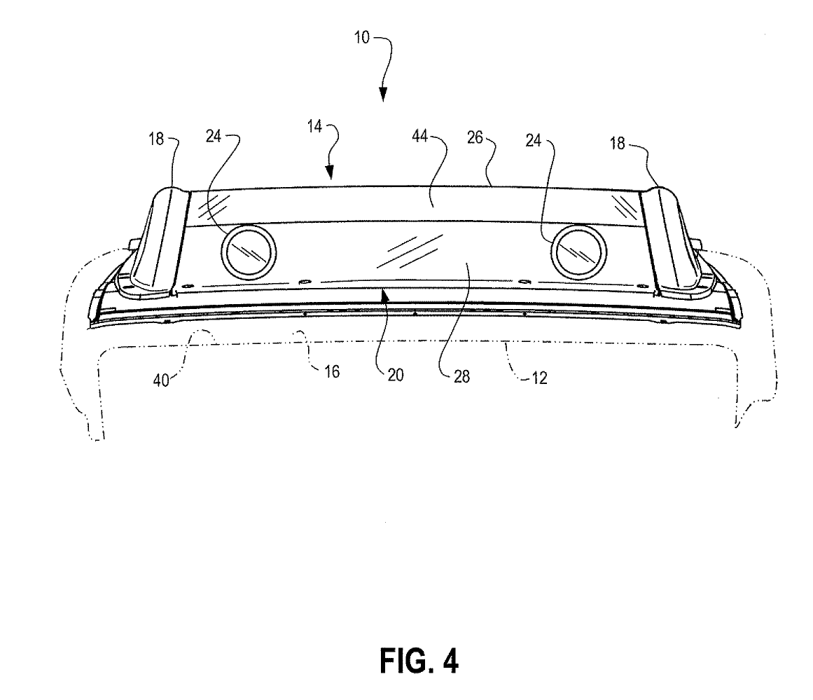

Referring to FIGS. 1-4, an exterior article carrier system 10 for a vehicle 12 is illustrated. The article carrier system 10 can include a load carrier rack 14 mountable to a roof 16 of the vehicle 12. The rack 14 has two side members 18 and an air deflector portion 20 located adjacent a forward end of the rack 14. The air deflector portion 20 extends between the two side members 18. At least one cross member 22 can extend between the two side members 18 at position located between the forward end and rearward end of the two side members 18. The cross member 22 extends generally transversely to the longitudinal axis of the vehicle 12. The wind or air deflector portion 20 directs an apparent flow of air with respect to the rack 14, as the rack 14 is moved by the vehicle 12. The exterior article carrier system 10 also includes at least one illumination light source 24 mounted within the air deflector portion 20 of the rack 14 for casting visible radiant light in a direction forward of the vehicle 12 to render objects in that direction visible.

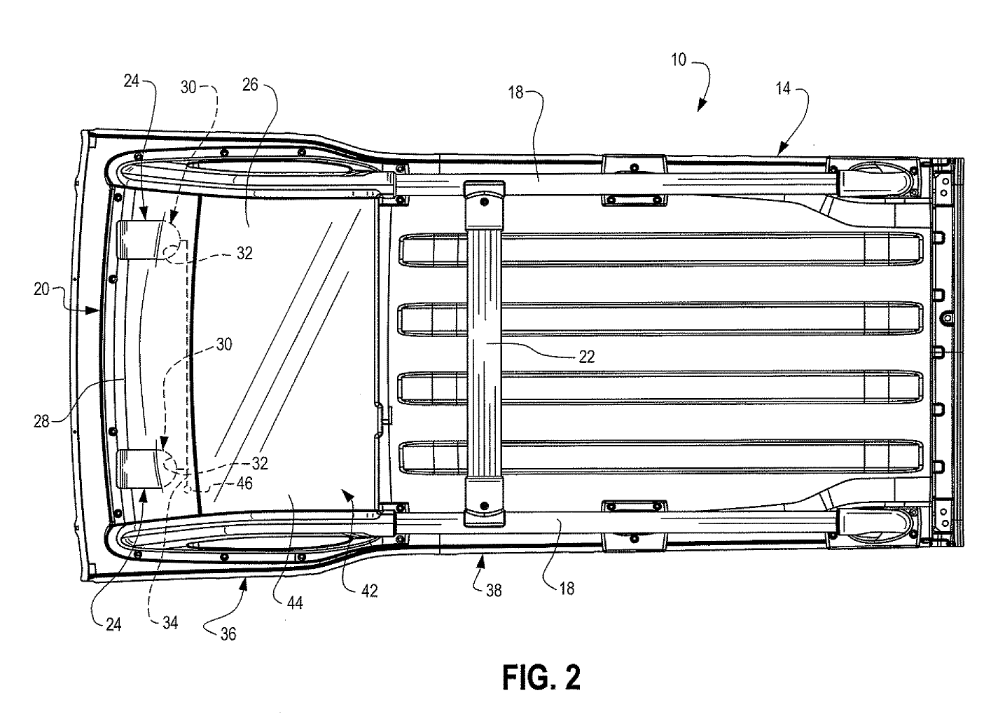

The at least one illumination light source 24 can include exterior, marker, auxiliary, signaling, off-road lights, and/or fog lights. The light sources can be any desired structural configuration, including round, rectangular, square, oval, or the like. The light source 22 is located between the two side members 18. The light source 24 can be located below an uppermost edge 26 of the air deflector portion 20 of the roof rack 14. In one embodiment of the present invention, the at least one light source 24 can include two spacially separated light sources 24 positioned within individual pockets or housings incorporated within or supported by a single enclosure 28 defined by the air deflector portion 20 of the rack 14. A rear portion 30 of the at least one light source 24 can be concealed behind the individual housing or forward facing surface of the air deflector portion 20 of the load carrier rack 14. A light source mounting bracket or portion 32 of the pocket or housing can be integrally formed in the air deflector portion 20 of the rack 14. An electrical connection 34 for the at least one light source 24 can be routed through a waterproof connection 46 (FIG. 2) in the roof 16 of the vehicle 12 beneath the air deflector portion 20 of the rack 14.

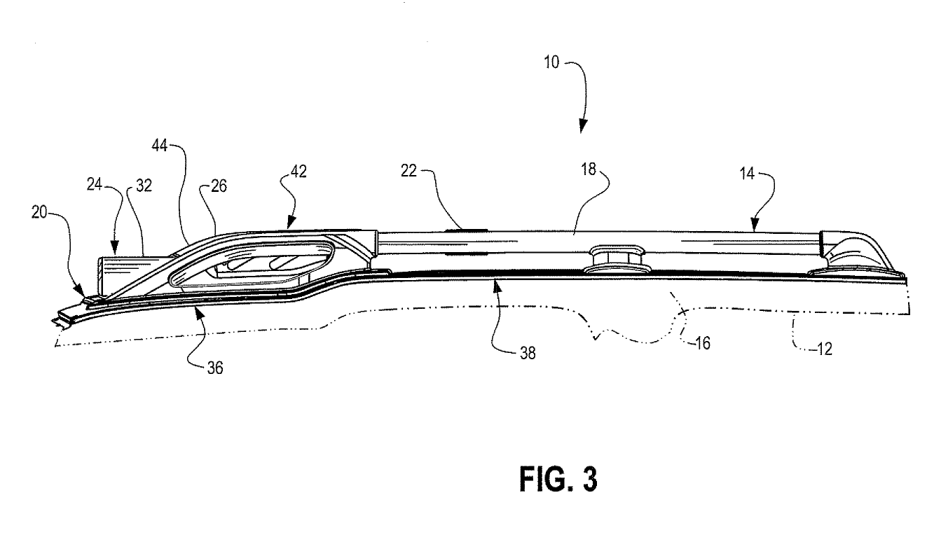

As best seen in FIGS. 1 and 3 the rack 14 is mountable on a roof 16 of a vehicle 12 having two different levels of elevation 36, 38. The air deflector portion 20 of the rack 14 substantially continues an angle of a windshield 40 of the vehicle 12. The air deflector portion 20 can interconnect the side members 18 of the rack 14. The interconnection between the air deflector portion 20 and the side members 18 can provide additional stiffness and an anchoring location for securing cargo or articles to the load carrier 14. In one embodiment of the present invention, the air deflector portion 20 can be removable from the rack 14.

In one embodiment of the present invention, a bin basket portion 42 of the rack 14 can be positioned rearward of the light source 24. A cover 44 can be provided on the basket 42 forming an uppermost edge 26 of the rack 14. The cover 44 can continue an angle of the air deflector portion 20 as best seen in FIGS. 1 and 3. Additional information regarding the rack 14 and/or bin 42 can be obtained from U.S. Patent Application No. US 2006/0151554 A1, which is incorporated herein in its entirety.

According to one embodiment of the present invention, off-road lights can be mounted in the roof rack air dam. This type of integration allows for ideal light placement and also good wind noise performance, since the air dam can be used to direct the wind flow. Integrating the light source with the air deflector does not significantly add turbulence, while allowing decorative, non-flush configurations to meet consumer styling preferences. Light sources located below the upper surface of the air deflector allow for less wind noise over the roof. The integration of light sources below the upper surface of the air deflector does not add to the height of the vehicle. The light system can be a direct replacement of the air dam, allowing for the roof rack light air dam to be used in place of the regular air dam. The integration of light system into the air dam also allows continued use of the bin and lid configuration. The lights can be integrated into the air dam, rather than be mounted on a stand alone light support bar.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An exterior article carrier system for a vehicle comprising:
a load carrier rack mountable to a roof of a vehicle, the rack having two side members and an air deflector portion located adjacent a forward end of the rack extending between the two side members, the deflector portion for directing an apparent flow of air with respect to the rack as the rack is moved by the vehicle; and
at least one illumination light source mounted within the air deflector portion of the rack for casting visible radiant light in a direction forward of the vehicle to render objects in that direction visible.

2. The exterior article carrier system of claim 1, wherein the at least one light source is located between the two side members.

3. The exterior article carrier of claim 1, wherein the at least one light source is located below an uppermost edge of the air deflector portion of the roof rack.

4. The exterior article carrier system of claim 1, wherein the at least one light source further comprises:
two spatially separate light sources positioned within a single enclosure defined by the air deflector portion of the rack.

5. The exterior article carrier system of claim 1 further comprising:
a basket portion of the rack positioned rearward of the light source.

6. The exterior article carrier system of claim 5 further comprising:
a cover on the basket portion forming an uppermost edge of the rack.

7. The exterior article carrier system of claim 6, wherein the cover continues an angle of the air deflector portion.

8. The exterior article carrier system of claim 1, wherein the air deflector portion substantially continues an angle of a windshield of the vehicle.

9. The exterior article carrier system of claim 1, wherein the air deflector portion interconnects the side members of the rack.

10. The exterior article carrier system of claim 1, wherein the air deflector portion is removable from the rack.

11. The exterior article carrier system of claim 1, wherein a rear portion of the at least one light source is concealed behind the air deflector portion.

12. The exterior article carrier system of claim 1 further comprising:
an electrical connection for the at least one light source is routed through a portion of the roof of the vehicle beneath the air deflector portion.

13. The exterior article carrier system of claim 1 further comprising:
a light source mounting portion integrated in the air deflector portion.

14. The exterior article carrier system of claim 1, wherein the rack is mountable on a roof of a vehicle having two different levels of elevation.

15. An exterior article carrier system for a vehicle comprising:
a load carrier rack mountable to a roof of a vehicle, the rack having two side members and an air deflector portion located adjacent a forward end of the rack extending between the two side members, the deflector portion for directing an apparent flow of air with respect to the rack as the rack is moved by the vehicle, the air deflector interconnecting the side members of the rack;
two spatially separate light sources mounted within a single enclosure defined by the air deflector portion of the rack for casting visible radiant light in a direction forward of the vehicle to render objects in that direction visible, each light source located between the two side members and below an uppermost edge of the air deflector portion of the roof rack, a rear portion of each light source concealed behind the air deflector portion; and
an electrical connection for the light sources routed through a portion of the roof of the vehicle beneath the air deflector portion.

16. The exterior article carrier system of claim 15 further comprising:
a light source mounting portion integrated in the air deflector portion.

17. The exterior article carrier system of claim 15, wherein the rack is mountable on a roof of a vehicle having two different levels of elevation.

18. The exterior article carrier system of claim 15 further comprising:
a basket portion of the rack positioned rearward of the light source; and
a cover on the basket portion forming an uppermost edge of the rack, wherein the cover continues an angle of the air deflector portion, and the air deflector portion substantially continues an angle of a windshield of the vehicle.

19. The exterior article carrier system of claim 15, wherein the air deflector portion is removable from the rack.
